(19) United States
(12) Patent Application Publication
(10) Pub. No.: US 2023/0072618 A1
(43) Pub. Date: Mar. 9, 2023

(54) MULTI-LAYER, OIL-RESISTANT, ELECTRO-MECHANICAL SYNTHETIC HEPA MEDIA

(71) Applicant: Columbus Industries, Inc., Ashville, OH (US)

(72) Inventor: Russell L. Baldinger, Dublin, OH (US)

(21) Appl. No.: 17/939,454

(22) Filed: Sep. 7, 2022

Related U.S. Application Data
(60) Provisional application No. 63/241,267, filed on Sep. 7, 2021.

(51) Int. Cl. B01D 39/20; B01D 29/00; B01D 35/06; B01D 29/90

(52) U.S. Cl. CPC B01D 39/2017; B01D 29/0036; B01D 35/06; B01D 29/90; B01D 39/2055; B01D 2201/0415; B01D 2239/0241; B01D 2239/0618; B01D 2258/06; B01D 2273/30; B01D 2275/10; B01D 2279/50

(57) ABSTRACT

A composite media alternative to high pressure drop glass microfiber HEPA media for use in applications where HEPA efficiency with an oily aerosol challenge with low resistance are required. The composite media contains two light filtration layers, one or both of which is charged, and the efficiency of the material can be greatly increased over a single layer containing the same weight of material. The composite media contains a backer layer to provide mechanical support to the filtration layers.

### FIELD AND BACKGROUND OF THE INVENTION

The invention relates to filtration media generally, and more particularly to a glass and/or synthetic, non-woven filtration media that has multiple layers and is not negatively affected by oily aerosols.

Traditional synthetic HEPA materials are designed and used to filter dry (non-oily) particulate in the air. The traditional material used to filter oily aerosols with HEPA efficiencies (greater than 99.97% at 0.1 micron or larger) has been glass microfiber. Glass microfibers are traditionally made using very small glass fibers that are homogenously mixed in a liquid solution and then dried into a continuous sheet similar to the way paper is made from liquid pulp. The materials made in this traditional filter making method are very dense and thus create a very efficient mechanical means of capturing small particles. Because the means of capturing is mechanical (i.e., straining of particles), these materials capture dry and oily aerosols with equal ease. The disadvantage to such a construction is that the resistance to airflow through the filter is very high. Another way of stating this is that such filters have a large pressure drop.

The traditional filters made from glass microfibers must be very large (i.e., high surface area) and the appliances used to move air through these filters must have a high degree of power to overcome the high resistance to flow therethrough. This requirement for a high-powered appliance increases the cost and power consumption of the appliance and typically results in a higher operating noise that people find irritating. Thus, when resistance to oily aerosols is required, high-resistant mechanical filtration materials are conventionally used to form the media, but this media requires large motors to force the air through the media. To overcome these large, noisy appliances, the industry has turned to low resistant, electrostatically charged filtration materials.

The efficiency of traditional, charged fiber filtration media is adversely affected when exposed to oily aerosols. The typical approach to this dilemma is to use a single layer of heavy weight charged fiber material made using a meltblown process. The difficulty is that all known charging methods for meltblown media have a limitation as to how much charge can be applied to the materials as weight increases.

### SUMMARY OF THE INVENTION

Disclosed herein is a composite media developed as an alternative to high resistant (large pressure drop), mechanical, glass microfiber HEPA media for use in applications where HEPA efficiency with an oily aerosol challenge with low resistance are required. The disclosed media contains at least two lighter filtration layers, at least a downstream one of which is charged, and the upstream one of which removes most or all of the particles in the airstream that would otherwise mask the charge of the downstream layer. The disclosed media also includes a backer layer that provides mechanical support, pre-filtration when placed upstream, and provides means by which the filtration layer can be pleated to create an extended surface, low resistant, HEPA filter. The efficiency of the material can be greatly increased over a single layer containing the same weight of material as the combined weight of the filtration layers described herein.

The disclosed embodiments provide a low pressure drop alternative for filtering air where very high removal of oily aerosols, and low resistance to air flow, is needed. The disclosed media has a longer life, a lower pressure drop and greater efficiency than conventional media of equivalent weight.

One contemplated use for this media is in restoration and recovery air moving appliances that are used to clean the air in an area affected by fire or flood. Another contemplated use is room air purification. While this technology could be used in residential and industrial HVAC systems, this is not a preferred use.

Prior to the disclosed media, it has not been possible to obtain HEPA efficiencies when filtering oily aerosols without using high-powered appliances. Instead, glass fibers have been used conventionally, and the pressure drop using these fibers has been unacceptably high. With the disclosed media, one can obtain HEPA efficiency when filtering oily aerosols, and the pressure drop is substantially smaller than with the prior art.

The disclosed media has an upstream filtration layer that removes most or all of the non-oily particles in the air by straining and/or electrostatic attraction. Thus, when the oily aerosol particles reach the charged, downstream filtration layer, the oily particles are removed from the air stream by electrostatic attraction. In this manner, the electrostatic attraction of the downstream layer is not masked, or not masked as quickly, by the non-oily particles, because most non-oily particles do not make it past the upstream filtration layer.

### BRIEF DESCRIPTION OF DRAWINGS

FIG. 1 is a schematic side view in section illustrating a first embodiment of the present invention.

FIG. 2 is a schematic side view in section illustrating a second embodiment of the present invention.

FIG. 3 is a schematic side view in section illustrating an embodiment of the invention in filter form.

FIG. 4 is a schematic side view illustrating an embodiment of the invention in a conventional HVAC system.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

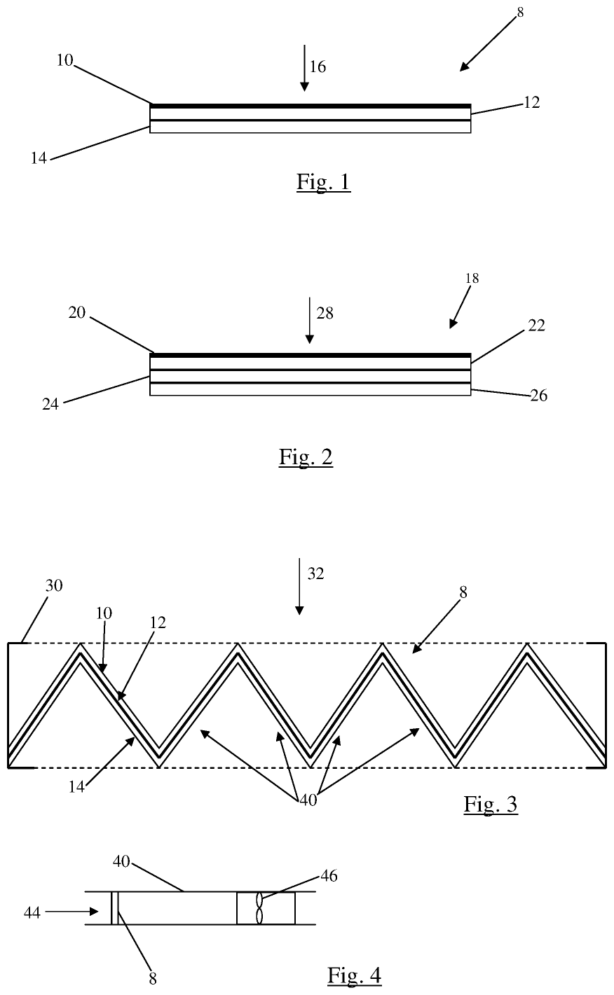

Disclosed herein is a composite media 8 that includes at least three layers: a backer layer 10 and two filtration layers 12 and 14 mounted to the backer layer 10, as shown in FIG. 1. Flowing air 16 contacts the backer layer 10 first in the embodiment of FIG. 1. The media 8 is preferably arranged with the backer layer 10 as the most upstream layer followed (progressing downstream) by the filtration layers 12 and 14. The filtration layers 12 and 14 may be identical, or they may vary substantially. One or both filtration layers may be charged for particle removal, but at least the second filtration layer 14, which is the most downstream in the composite media 8, is charged to remove particles.

In one embodiment, all layers of the media are synthetic (polymer). In another embodiment, all layers of the media are glass. In yet another embodiment, each of the layers of the media is a combination of synthetic and glass. In still another embodiment, each of the layers is of only one type of material, but the layers differ in material type, among synthetic and glass. The backer layer 10 is preferably a non-woven media, which may be any material, such as synthetic fibers or glass fibers. The fibers may be coarse or fine. For example, the fibers of the backer layer may be between 10 and 40 microns in diameter. The backer layer 10 is used as a “carrier” and “support layer” for the filtration layers 12 and 14 that are applied to it, either directly or through another layer, and thus the backer layer 10 provides mechanical support to the filtration layers 12 and 14. The backer layer 10 preferably does not substantially inhibit the flow of air through it. That is, the pressure drop through the backer layer 10 alone is zero or nearly zero when measured by common equipment.

The layers may be assembled in the form of a filter (e.g., with a rigid frame that permits installation in a conventional manner), and placed in a restoration and recovery unit where air moving appliances are used to clean the air of an area affected by fire or flood. Alternatively, the filter may be used in an air purification device, such as a room air purifier. In either context, a contemplated system (shown in FIG. 4) may have a housing or ducting 40, a fan 46 and air 44 flowing through the media 8. The air (reference numeral 16 in FIG. 1) to be filtered flows through the backer layer 10 first, and then through the filtration layers 12 and 14. Thus, the backer layer 10 may be the most “upstream” layer of the filtration media when the media 8 is placed in an operable position (e.g., as in FIG. 4), but in alternative embodiments the backer layer may be the most downstream layer or it may be intermediate the filtration layers.

The backer layer 10 is designed to support the two or more layers 12, 14 of filtration media in flat form (as shown in FIG. 1) and folded form (known as “pleated” and shown in FIG. 3). The backer layer 10 may also pre-filter the air of larger effluent. The backer layer 10 is preferably designed to capture only particles larger than about 10 micron. The backer layer can also or alternatively be impregnated with carbon or other materials that assist in the removal of unwanted gasses and odors that are in the air. In the case of the backer layer being impregnated with, for example, carbon materials that remove gasses and odors from the air, the preferred position of the backer is downstream of the filtration layer so that the carbon is protected from being coated with either dry or wet particulate that is in the filtering airstream.

The first filtration layer 12 may be any filtration media, such as a polymer (e.g., polypropylene) fiber media formed in a meltblown process. The filtration layer 12 may be charged, such as by any charging method, or it may be used in a virgin, uncharged state. The filtration layer 12 may be identical in fiber structure to the second filtration layer 14, or the fiber structure of the layer 12 may be larger than the fibers of the second filtration layer 14.

The intended purpose of the filtration layer 12 is to “polish” the air stream of dry particles before the air enters the second filtration layer 14. Thus, this first filtration layer 12 may be designed to target any effluent that exists in the air stream. The filtration layer 12 is designed to capture the majority (>99%) of the contaminants in the air stream and depth load to maintain a low resistance to airflow as the media 8 loads with contaminants. The filtration layer 12 may transition to mostly mechanical particulate removal from mostly electrostatic particulate removal as the layer 12 loads with contaminants. However, if the filtration layer 12 is not charged, it will remove particulate mechanically the entire life of the filter media 8. The filtration layer 12 may be infused with nanoparticles.

The first filtration layer 12 should have enough mass, density and smaller fiber diameter so that it can perform some mechanical capture of particles in the air. It is also contemplated that the first filtration layer 12 may be charged to capture particles by an electrostatic mechanism. The first filtration layer 12 may capture particles by any means or mechanism.

As an example, the first filter layer 12 may be a non-woven fiber layer having a weight of 34 to 40 grams per square meter (g/m²), a fiber diameter distribution in the range of 2.0 to 5.0 microns with most fibers preferably in the range of 2.0 to 3.0 microns. The first filter layer 12 may be made of a polymer, such as polypropylene, and the media may be formed in a meltblown process. The flat sheet efficiency of the first filter layer 12 with oily aerosols is at least 99.97% at a resistance of no greater than 6.0 millimeters of water at 10.5 feet per minute of air velocity. The filtration layer 12 is designed to remove more than 99.97% of oily airborne particles down to 0.1 micron (100 nanometer) in size.

The second filtration layer 14 may be substantially the same as the first layer 12, such as by using another layer of the same media as is used for the first layer 12. The second layer 14 may be a highly charged layer of a nonwoven filtration media, which may be a polymer (e.g., polypropylene) fiber media formed in a meltblown or other process. The filtration layer 14 is designed to deliver HEPA efficiency over the life of media 8. The second filtration layer 14 is highly charged and will maintain its ability to filter the air using electrostatic forces through the lifetime of the media 8 as the filtration layer's 14 means of capturing particles in the airstream.

As an example, the second filter layer 14 may have a weight of 21-34 g/m², a fiber diameter distribution in the range of 2.0 to 5.0 microns, with most fibers preferably in the range of 4.0 to 5.0 microns. A filtration layer with a weight above 40 g/m² is difficult to charge through its entire thickness using existing technologies, and so this presents a practical limitation on weight for any filtration layer. The first filter layer 12 may be made of a polymer, such as polypropylene, and the non-woven fiber media may be formed in a meltblown process. The flat sheet efficiency of the first filter layer 12 with oily aerosols is at least 95-98% at a resistance of no greater than 1.5 to 2.5 millimeters of water at 10.5 feet per minute of air velocity. The filtration layer 14 is designed to remove more than 99.97% of oily airborne particles down to 0.1 micron (100 nanometer) in size.

The layers 10, 12 and 14 may be held together by a light application of adhesive that is conventional, but other means are contemplated. The composite of the multiple layers could also be held together by any mechanical means such as ultrasonic point bonding.

One would expect three or more layers, as in the example above, to yield a composite media that has three times the resistance (pressure drop) of equivalent mechanical filtration materials. However, the combination of these three layers yields a composite media that filters oily aerosols from the airstream with less than 3 times the resistance of equivalent mechanical filtration materials.

The electro-mechanical synthetic HEPA media pre-filters the air as it moves through the first two layers 10 and 12 so that the second filtration layer 14 can filter dry and oily aerosols without losing efficiency. The resistance of the composite media 8 is typically less than 3 times that of a mechanical media of the same efficiency. Filters made from the described media can thus be designed to be smaller while delivering the same efficiency. Also, the appliances used to move air through these filters can be smaller and require less energy to filter the same amount of air in the same amount of time.

The composite filtration media 18 shown in FIG. 2 is another embodiment and has a backer layer 20, a first filtration layer 22, a second filtration layer 24 and a third filtration layer 26. The air flows in the direction designated by the arrow 28. All layers 20-26 are similar to the corresponding layers 10-14 of the filtration media 8 described above and are formed in a similar manner, but with an additional filtration layer. This third filtration layer 26 illustrates that the embodiments of the invention contemplated may have at least three layers as in the media 8, but may have more than three layers as in the media 18, and in some cases many more than three layers.

The composite filtration media 8 shown in FIG. 1 may be in a flat form or may be pleated, as shown in FIG. 3, which is a schematic section view illustrating the three layers 10, 12 and 14 of the media 8 in the pleated form and with a frame 30 surrounding the media 8. The layers 10, 12 and 14 are aligned with the air flow, designated by the arrow 32. Each of the pleated “panels” 40 is angled relative to an adjacent panel at about 60 to 120 degrees.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A composite gas filtration media comprising:
(a) a backer layer for mechanically supporting the composite gas filtration media and pre-filtering any gas that flows therethrough, the backer layer having an upstream surface and a downstream surface;
(b) a first non-woven filtration layer having an upstream surface and a downstream surface, the first non-woven filtration layer's upstream surface mounted to the downstream surface of the backer layer; and
(c) a second non-woven filtration layer having an upstream surface and a downstream surface, the second non-woven filtration layer's upstream surface mounted to the downstream surface of the first non-woven filtration layer, wherein at least the second non-woven filtration layer is electrostatically charged.

2. The composite gas filtration media in accordance with claim 1, wherein the first non-woven filtration layer is electrostatically charged.

3. The composite gas filtration media in accordance with claim 1, wherein the backer layer contains carbonaceous material for removing predetermined gaseous species from any gas that flows through the composite gas filtration media.

4. The composite gas filtration media in accordance with claim 3, wherein the backer layer is positioned downstream of at least the first non-woven filtration layer.

5. An apparatus comprising:
(a) a room containing air with a quantity of oily particles that is unhealthy for long term human respiration;
(b) an impeller disposed in the room with a composite gas filtration media disposed adjacent the impeller, whereby, when the impeller is operating, at least some of the air in the room is forced through the composite gas filtration media to remove at least some of the oily particles, wherein the composite gas filtration media comprises:
(i) a backer layer for mechanically supporting the composite media, the backer layer having an upstream surface and a downstream surface;
(ii) a first non-woven filtration layer having an upstream surface and a downstream surface, the first layer's upstream surface mounted to the downstream surface of the backer layer; and
(iii) a second non-woven filtration layer having an upstream surface and a downstream surface, the second non-woven filtration layer's upstream surface mounted to the downstream surface of the first non-woven filtration layer, wherein at least the second non-woven filtration layer is electrostatically charged.

6. A method of removing oily particles from air, the method comprising:
(a) forcing the air through a composite gas filtration media comprising:
(i) a backer layer for mechanically supporting the composite media, the backer layer having an upstream surface and a downstream surface;
(ii) a first non-woven filtration layer having an upstream surface and a downstream surface, the first layer's upstream surface mounted to the downstream surface of the backer layer; and
(iii) a second non-woven filtration layer having an upstream surface and a downstream surface, the second layer's upstream surface mounted to the downstream surface of the first filtration layer, wherein at least the second filtration layer is electrostatically charged;
(b) disposing in the first non-woven filtration layer at least about 99% of the non-oily particles in the air that passes through the first non-woven filtration layer; and
(c) disposing in the second non-woven filtration layer at least about 99% of the oily particles in the air that passes through the second non-woven filtration layer.

7. The method in accordance with claim 6, wherein the step of disposing in the second non-woven filtration layer comprises electrostatic attraction of the oily particles that are disposed in the second non-woven filtration layer.
